(19) United States
(12) Patent Application Publication
(10) Pub. No.: US 2008/0229876 A1
(43) Pub. Date: Sep. 25, 2008

(54) Foldable Pedal that is Folded Easily and Quickly

(76) Inventor: Chin-Long Hsieh, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/939,606

(22) Filed: Nov. 14, 2007

(30) Foreign Application Priority Data
Mar. 23, 2007 (TW) 096204745

(51) Int. Cl. B62M 3/08

(52) U.S. Cl. 74/594.7

(57) ABSTRACT

A foldable pedal includes an inner pedal body, an outer pedal body provided with a receiving chamber and a receiving channel, a biasing mechanism including a resting bar and a compression spring, and a stop member movably mounted in the receiving channel and provided with a through hole that is movable to align with the receiving chamber to allow passage of the resting bar. Thus, the outer pedal body is locked on the inner pedal body by an interlocking action of the resting bar and the stop member, so that the compression spring biased between the outer pedal body and the resting bar needs not to have a higher strength, and a user only needs to apply a little force to compress the compression spring so as to fold the foldable pedal easily and conveniently.

### BACKGROUND OF THE INVENTION

1. Field of the Invention

The present invention relates to a pedal and, more particularly, to a foldable pedal for a bicycle.

2. Description of the Related Art

A conventional foldable pedal comprises an inner pedal body, an outer pedal body pivotally and movably mounted on the inner pedal body and a compression spring biased between the inner pedal body and the outer pedal body to push the outer pedal body outwardly relative to the inner pedal body. Thus, when the outer pedal body is pushed toward the inner pedal body to compress the compression spring, the outer pedal body can be pivoted relative to the inner pedal through an angle of ninety degrees so that the outer pedal body is perpendicular to the inner pedal so as to fold the pedal. When the outer pedal body is returned to the original state to be in line with the inner pedal, the outer pedal body is pushed outwardly relative to the inner pedal body by the restoring force of the compression spring so as to expand the pedal. However, the compression spring needs to have a greater strength to prevent the outer pedal body from being pushed toward the inner pedal body easily, so that a user has to apply a greater force to compress the compression spring, thereby causing inconvenience to the user when folding the pedal.

### BRIEF SUMMARY OF THE INVENTION

The primary objective of the present invention is to provide a foldable pedal that is folded easily and quickly.

Another objective of the present invention is to provide a foldable pedal, wherein the outer pedal body is locked on the inner pedal body by an interlocking action of the resting bar of the biasing mechanism and the stop member, so that the compression spring of the biasing mechanism biased between the outer pedal body and the resting bar needs not to have a higher strength, and a user only needs to apply a little force to compress the compression spring to move the outer pedal body toward the inner pedal body so as to fold the foldable pedal easily and conveniently.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a foldable pedal in accordance with the preferred embodiment of the present invention.

FIG. 2 is an exploded perspective view of the foldable pedal as shown in FIG. 1.

FIG. 3 is a partially top cross-sectional view of the foldable pedal as shown in FIG. 1.

FIG. 4 is a partially front cross-sectional view of the foldable pedal as shown in FIG. 1.

FIG. 5 is a schematic operational view of the foldable pedal as shown in FIG. 3.

FIG. 6 is a schematic operational view of the foldable pedal as shown in FIG. 4.

FIG. 7 is a schematic operational view of the foldable pedal as shown in FIG. 6.

FIG. 8 is a schematic operational view of the foldable pedal as shown in FIG. 1.

### DETAILED DESCRIPTION OF THE INVENTION

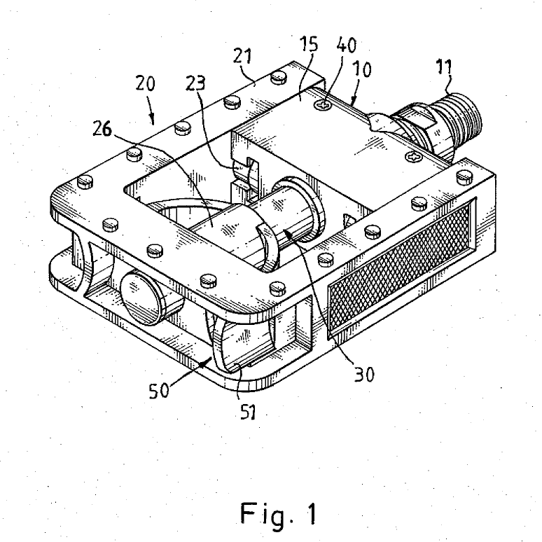

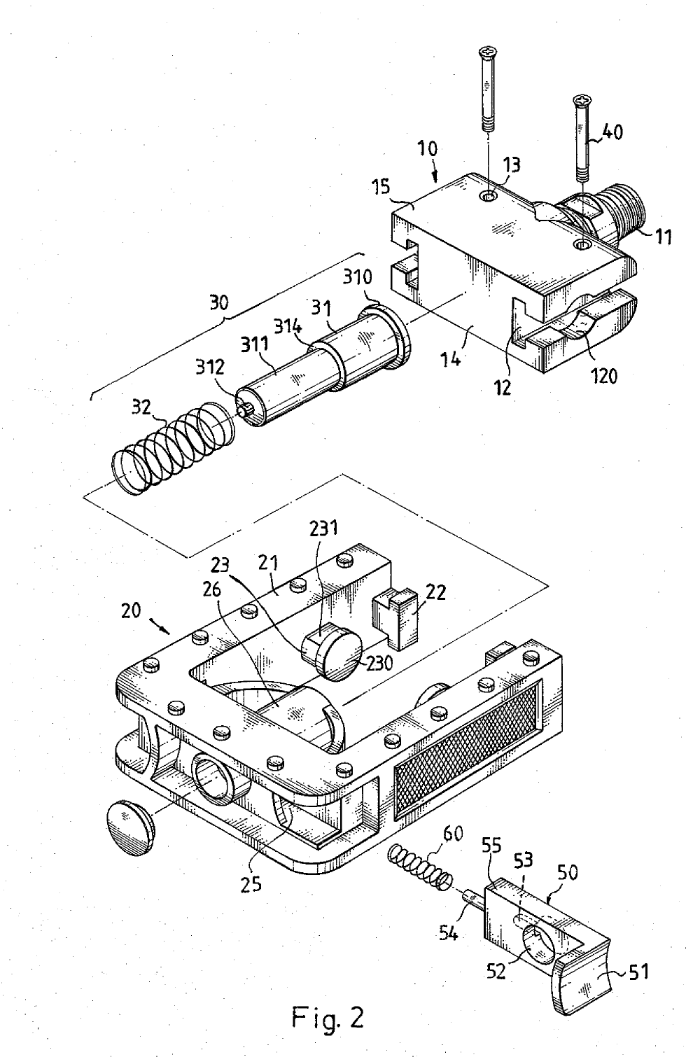

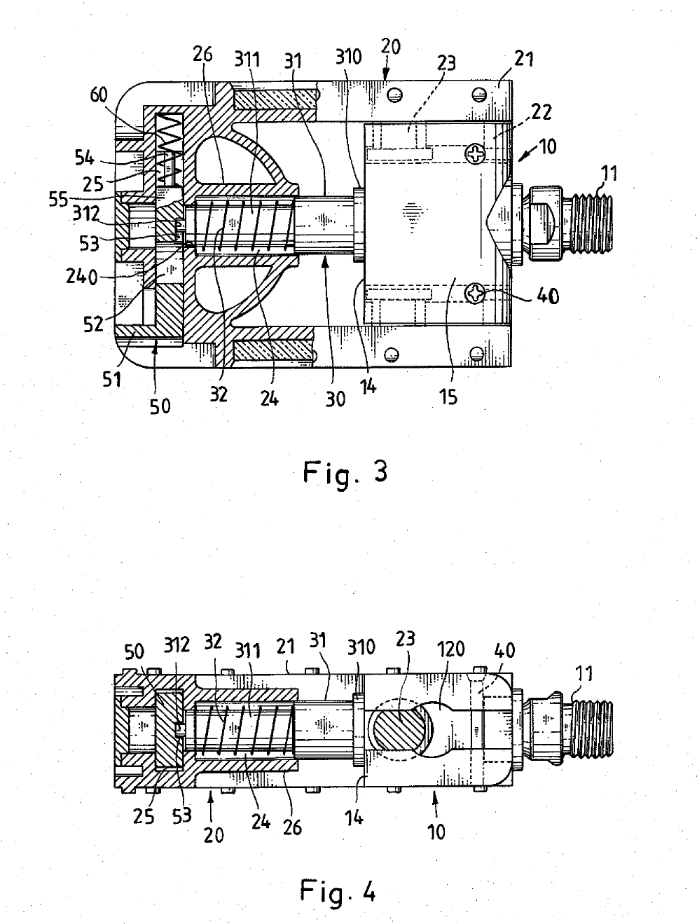

Referring to the drawings and initially to FIGS. 1-4, a foldable pedal in accordance with the preferred embodiment of the present invention comprises an inner pedal body 10, an outer pedal body 20 pivotally and movably mounted on the inner pedal body 10 and provided with a receiving chamber 24 movable relative to the inner pedal body 10 and a receiving channel 25 connected to the receiving chamber 24, a biasing mechanism 30 biased between the inner pedal body 10 and the outer pedal body 20 to push the outer pedal body 20 outwardly relative to the inner pedal body 10 and including a resting bar 31 abutting the inner pedal body 10 and movable in the receiving chamber 24 of the outer pedal body 20 when the outer pedal body 20 is movable relative to the inner pedal body 10, and a stop member 50 movably mounted in the receiving channel 25 of the outer pedal body 20 and provided with a through hole 52 that is movable to align with the receiving chamber 24 of the outer pedal body 20 to allow passage of the resting bar 31 of the biasing mechanism 30 when the outer pedal body 20 is movable relative to the inner pedal body 10.

Thus, the stop member 50 is movable relative to the receiving chamber 24 of the outer pedal body 20 between a first position where the through hole 52 of the stop member 50 is separated from the receiving chamber 24 of the outer pedal body 20, the stop member 50 abuts the resting bar 31 of the biasing mechanism 30, and the outer pedal body 20 is fixed on the resting bar 31 of the biasing mechanism 30 by the stop member 50 and is not movable relative to the inner pedal body 10, and a second position where the through hole 52 of the stop member 50 aligns with the receiving chamber 24 of the outer pedal body 20 to allow passage of the resting bar 31 of the biasing mechanism 30 and to unlock the outer pedal body 20 from the resting bar 31 of the biasing mechanism 30, the receiving chamber 24 of the outer pedal body 20 is movable on the resting bar 31 of the biasing mechanism 30, and the outer pedal body 20 is movable relative to the inner pedal body 10.

The inner pedal body 10 has a first end provided with a protruding mandrel 11 connected to a crank (not shown) and a second end provided with an upright face 14. The inner pedal body 10 has an upper face 15 perpendicular to the upright face 14. The inner pedal body 10 has two opposite sides each provided with a substantially T-shaped slideway 12 which has an outer side provided with a circular pivot opening 120. Each of the two opposite sides of the inner pedal body 10 is provided with an upright pin hole 13 connected to the respective slideway 12.

The outer pedal body 20 is substantially U-shaped and has two opposite side walls 21 movable on the inner pedal body 10. Each of the two opposite side walls 21 of the outer pedal body 20 has an inner face provided with a substantially T-shaped slide 22 slidable in the respective slideway 12 of the inner pedal body 10 and a pivot shaft 23 pivotable in the pivot opening 120 of the respective slideway 12 of the inner pedal body 10. The pivot shaft 23 of the outer pedal body 20 is slidable in the respective slideway 12 of the inner pedal body 10 and located between the respective slide 22 and the receiving chamber 24. The pivot shaft 23 of the outer pedal body 20 is a circular post and has a diameter smaller than that of the pivot opening 120 of the respective slideway 12 of the inner pedal body 10. The pivot shaft 23 of the outer pedal body 20 has a first end protruding from the respective side wall 21 and a second end provided with an enlarged limit flange 230 limited in the respective slideway 12 of the inner pedal body 10. The pivot shaft 23 of the outer pedal body 20 has a periphery provided with two radially opposite flattened guide faces 231 abutting a wall of the respective slideway 12 of the inner pedal body 10 to guide movement of the pivot shaft 23 of the outer pedal body 20 in the respective slideway 12 of the inner pedal body 10. The receiving chamber 24 of the outer pedal body 20 is defined by a mounting tube 26 directed toward the upright face 14 of the inner pedal body 10. The receiving channel 25 of the outer pedal body 20 is perpendicular to the receiving chamber 24. The outer pedal body 20 is provided with a stepped passage 240 connected between and located at an intersection of the receiving chamber 24 and the receiving channel 25.

The stop member 50 is substantially L-shaped and has a first end provided with a mover 55 movable in the receiving channel 25 of the outer pedal body 20 and a second end provided with a press button 51 protruding outwardly from the receiving channel 25 of the outer pedal body 20. The stop member 50 has a side provided with a retaining slot 53 connected to the through hole 52 and located between the through hole 52 and the mover 55.

A restoring spring 60 is received in the receiving channel 25 of the outer pedal body 20 and biased between the outer pedal body 20 and the mover 55 of the stop member 50 to push the stop member 50 outwardly relative to the receiving channel 25 of the outer pedal body 20 and to move the through hole 52 of the stop member 50 to space from the resting bar 31 of the biasing mechanism 30. The mover 55 of the stop member 50 has an end face provided with a protruding stub 54 for mounting the restoring spring 60.

The foldable pedal further comprises two upright stop bolts 40 each extending through the inner pedal body 10 and each located between the respective pivot shaft 23 and the respective slide 22 of the outer pedal body 20 to stop a further movement of the respective slide 22 of the outer pedal body 20. Each of the two stop bolts 40 extends through the respective pin hole 13 into the respective slideway 12 of the inner pedal body 10.

The resting bar 31 of the biasing mechanism 30 has a first end provided with an enlarged resting flange 310 resting on the upright face 14 of the inner pedal body 10 and a second end provided with a reduced mounting post 311 that extends through the receiving chamber 24 and the passage 240 of the outer pedal body 20 into the through hole 52 of the stop member 50 when the through hole 52 of the stop member 50 aligns with the receiving chamber 24 of the outer pedal body 20. The mounting post 311 of the resting bar 31 has an end face provided with a protruding limit boss 312 received in the retaining slot 53 of the stop member 50 to lock the stop member 50 onto the resting bar 31 of the biasing mechanism 30.

The biasing mechanism 30 further includes a compression spring 32 mounted on the resting bar 31 and biased between the receiving chamber 24 of the outer pedal body 20 and the resting bar 31 to push the outer pedal body 20 outwardly relative to the inner pedal body 10. The compression spring 32 of the biasing mechanism 30 is mounted on the mounting post 311 of the resting bar 31 and biased between a wall of the stepped passage 240 of the outer pedal body 20 and a stepped shoulder 314 of the resting bar 31.

As shown in FIGS. 1-4, the compression spring 32 of the biasing mechanism 30 pushes the outer pedal body 20 outwardly relative to the inner pedal body 10 so that the pivot shaft 23 of the outer pedal body 20 is spaced from the pivot opening 120 of the respective slideway 12 of the inner pedal body 10, and the through hole 52 of the stop member 50 is detached from the mounting post 311 of the resting bar 31. At this time, each of the two stop bolts 40 stops a further movement of the respective slide 22 of the outer pedal body 20. In addition, the restoring spring 60 pushes the stop member 50 outwardly relative to the receiving channel 25 of the outer pedal body 20 to separate the through hole 52 of the stop member 50 from the resting bar 31 of the biasing mechanism 30. At this time, the limit boss 312 of the resting bar 31 is received in the retaining slot 53 of the stop member 50 when the stop member 50 is movable outwardly relative to the receiving channel 25 of the outer pedal body 20 to lock the stop member 50 onto the resting bar 31 of the biasing mechanism 30. Thus, the outer pedal body 20 is fixed on the resting bar 31 of the biasing mechanism 30 by the stop member 50 and is not movable relative to the inner pedal body 10.

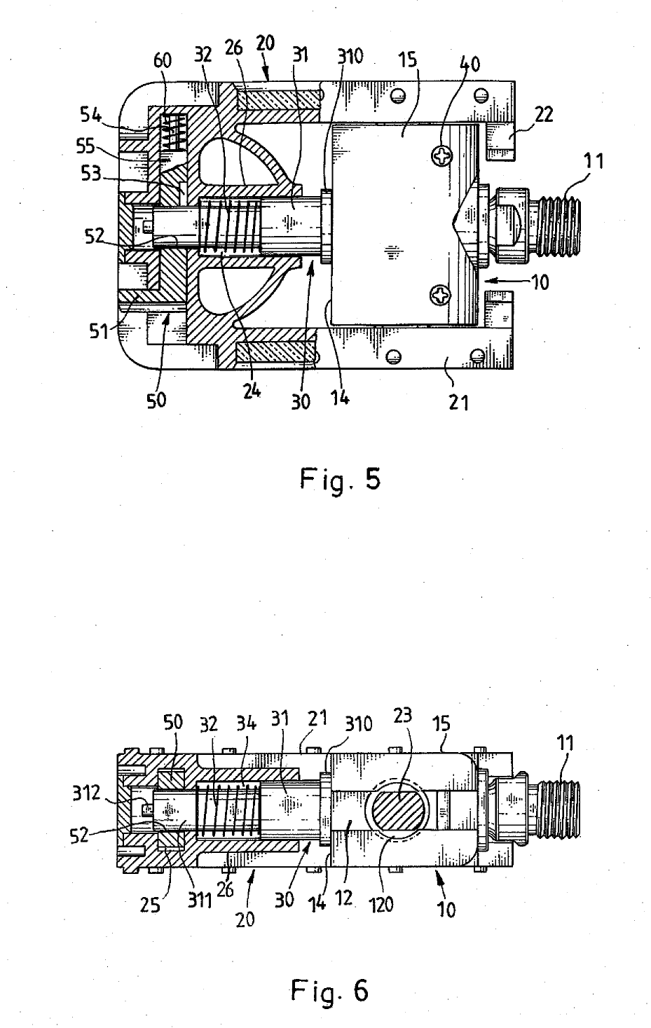

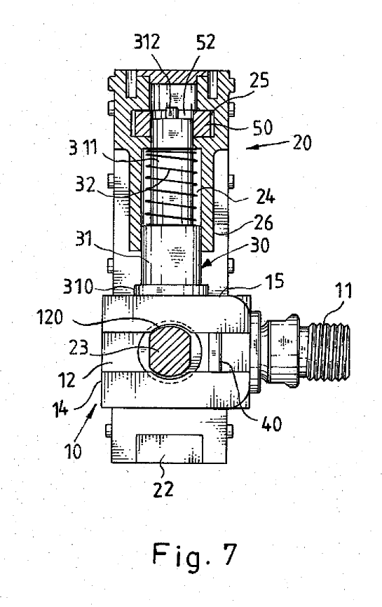

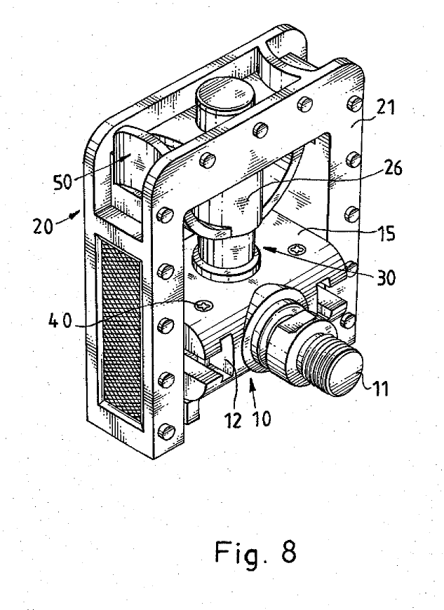

In operation, referring to FIGS. 5-8 with reference to FIGS. 1-4, when the press button 51 of the stop member is pressed, the stop member 50 is movable relative to the receiving chamber 24 of the outer pedal body 20 to release the limit boss 312 of the resting bar 31 from the retaining slot 53 of the stop member 50 and to align the through hole 52 of the stop member 50 with the receiving chamber 24 of the outer pedal body 20 as shown in FIGS. 5 and 6, so that the mounting post 311 of the resting bar 31 is allowed to pass through the through hole 52 of the stop member 50. Thus, the outer pedal body 20 is unlocked from the resting bar 31 of the biasing mechanism 30 by releasing the stop member 50 and is movable relative to the inner pedal body 10. When the outer pedal body 20 is movable toward the inner pedal body 10, the receiving chamber 24 of the outer pedal body 20 is movable on the resting bar 31 of the biasing mechanism 30, and the pivot shaft 23 of the outer pedal body 20 is movable to align with the pivot opening 120 of the respective slideway 12 of the inner pedal body 10, so that the pivot shaft 23 of the outer pedal body 20 can be pivoted in the pivot opening 120 of the respective slideway 12 of the inner pedal body 10. Thus, the outer pedal body 20 can be pivoted relative to the inner pedal body 10 through an angle of ninety degrees so that the outer pedal body 20 is perpendicular to the inner pedal body 10 as shown in FIGS. 7 and 8 so as to fold the foldable pedal. At this time, the resting flange 310 of the resting bar 31 abuts the upper face 15 of the inner pedal body 10. In such a manner, when the outer pedal body 20 is in line with the inner pedal body 10 as shown in FIG. 1, the foldable pedal is expanded, and when the outer pedal body 20 is perpendicular to the inner pedal body 10 as shown in FIG. 8, the foldable pedal is folded.

Accordingly, the outer pedal body 20 is locked on the inner pedal body 10 by an interlocking action of the resting bar 31 of the biasing mechanism 30 and the stop member 50, so that the compression spring 32 of the biasing mechanism 30 biased between the outer pedal body 20 and the resting bar 31 needs not to have a higher strength, and a user only needs to apply a little force to compress the compression spring 32 to move the outer pedal body 20 toward the inner pedal body 10 so as to fold the foldable pedal easily and conveniently.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A foldable pedal, comprising:
an inner pedal body;
an outer pedal body pivotally and movably mounted on the inner pedal body and provided with a receiving chamber movable relative to the inner pedal body and a receiving channel connected to the receiving chamber;
a biasing mechanism biased between the inner pedal body and the outer pedal body to push the outer pedal body outwardly relative to the inner pedal body and including a resting bar abutting the inner pedal body and movable in the receiving chamber of the outer pedal body when the outer pedal body is movable relative to the inner pedal body;
a stop member movably mounted in the receiving channel of the outer pedal body and provided with a through hole that is movable to align with the receiving chamber of the outer pedal body to allow passage of the resting bar of the biasing mechanism when the outer pedal body is movable relative to the inner pedal body.

2. The foldable pedal in accordance with claim 1, wherein the stop member is movable relative to the receiving chamber of the outer pedal body between a first position where the through hole of the stop member is separated from the receiving chamber of the outer pedal body, the stop member abuts the resting bar of the biasing mechanism, and the outer pedal body is fixed on the resting bar of the biasing mechanism by the stop member and is not movable relative to the inner pedal body, and a second position where the through hole of the stop member aligns with the receiving chamber of the outer pedal body to allow passage of the resting bar of the biasing mechanism and to unlock the outer pedal body from the resting bar of the biasing mechanism, the receiving chamber of the outer pedal body is movable on the resting bar of the biasing mechanism, and the outer pedal body is movable relative to the inner pedal body.

3. The foldable pedal in accordance with claim 1, wherein the stop member has a first end provided with a mover movable in the receiving channel of the outer pedal body and a second end provided with a press button protruding outwardly from the receiving channel of the outer pedal body.

4. The foldable pedal in accordance with claim 3, wherein the stop member is substantially L-shaped.

5. The foldable pedal in accordance with claim 3, wherein
the outer pedal body is provided with a stepped passage connected between and located at an intersection of the receiving chamber and the receiving channel;
the resting bar of the biasing mechanism has a first end provided with an enlarged resting flange resting on an upright face of the inner pedal body and a second end provided with a reduced mounting post that extends through the receiving chamber and the passage of the outer pedal body into the through hole of the stop member when the through hole of the stop member aligns with the receiving chamber of the outer pedal body.

6. The foldable pedal in accordance with claim 5, wherein
the stop member has a side provided with a retaining slot connected to the through hole and located between the through hole and the mover;
the mounting post of the resting bar has an end face provided with a protruding limit boss received in the retaining slot of the stop member.

7. The foldable pedal in accordance with claim 6, wherein the limit boss of the resting bar is received in the retaining slot of the stop member when the stop member is movable outwardly relative to the receiving channel of the outer pedal body to lock the stop member onto the resting bar of the biasing mechanism.

8. The foldable pedal in accordance with claim 5, wherein the biasing mechanism further includes a compression spring mounted on the resting bar and biased between the receiving chamber of the outer pedal body and the resting bar to push the outer pedal body outwardly relative to the inner pedal body so that the through hole of the stop member is detached from the mounting post of the resting bar.

9. The foldable pedal in accordance with claim 8, wherein the compression spring of the biasing mechanism is mounted on the mounting post of the resting bar and biased between a wall of the stepped passage of the outer pedal body and a stepped shoulder of the resting bar.

10. The foldable pedal in accordance with claim 3, further comprising a restoring spring received in the receiving channel of the outer pedal body and biased between the outer pedal body and the mover of the stop member to push the stop member outwardly relative to the receiving channel of the outer pedal body and to move the through hole of the stop member to space from the resting bar of the biasing mechanism.

11. The foldable pedal in accordance with claim 10, wherein the mover of the stop member has an end face provided with a protruding stub for mounting the restoring spring.

12. The foldable pedal in accordance with claim 1, wherein the receiving chamber of the outer pedal body is defined by a mounting tube directed toward the inner pedal body.

13. The foldable pedal in accordance with claim 1, wherein the receiving channel of the outer pedal body is perpendicular to the receiving chamber.

14. The foldable pedal in accordance with claim 1, wherein
the inner pedal body has two opposite sides each provided with a slideway which has an outer side provided with a pivot opening;
the outer pedal body has two opposite side walls movable on the inner pedal body;
each of the two opposite side walls of the outer pedal body has an inner face provided with a slide slidable in the respective slideway of the inner pedal body and a pivot shaft pivotable in the pivot opening of the respective slideway of the inner pedal body.

15. The foldable pedal in accordance with claim 14, wherein
the pivot shaft of the outer pedal body is slidable in the respective slideway of the inner pedal body and located between the respective slide and the receiving chamber;
the pivot shaft of the outer pedal body has a first end protruding from the respective side wall and a second end provided with an enlarged limit flange limited in the respective slideway of the inner pedal body;
the pivot shaft of the outer pedal body has a periphery provided with two radially opposite flattened guide faces abutting a wall of the respective slideway of the inner pedal body to guide movement of the pivot shaft of the outer pedal body in the respective slideway of the inner pedal body.

16. The foldable pedal in accordance with claim 6, wherein the stop member is movable relative to the receiving chamber of the outer pedal body to release the limit boss of the resting bar from the retaining slot of the stop member and to align the through hole of the stop member with the receiving chamber of the outer pedal body.
